(19) United States
(12) Patent Application Publication
(10) Pub. No.: US 2025/0150808 A1
(43) Pub. Date: May 8, 2025

(54) SUBSCRIPTION SERVICE FILE MANAGEMENT FOR ESIM TRANSFER

(71) Applicant: Apple Inc., Cupertino, CA (US)

(72) Inventors: Jean-Marc PADOVA, San Francisco, CA (US); Aurelien P. RABOISSON, San Diego, CA (US); Li LI, Los Altos, CA (US); Ngabin S. NG, San Diego, CA (US)

(21) Appl. No.: 18/810,144

(22) Filed: Aug. 20, 2024

Related U.S. Application Data
(60) Provisional application No. 63/596,561, filed on Nov. 6, 2023.

(51) Int. Cl. H04W 8/20; H04W 8/18

(52) U.S. Cl. CPC H04W 8/205; H04W 8/183

(57) ABSTRACT

The described embodiments set forth techniques for managing subscription service files, e.g., Customized Applications for Mobile network Enhanced Logic (CAMEL) Application Part (CAP) files, for export and/or transfer of an electronic SIM (eSIM) from a source wireless device. As part of an eSIM procedure to transfer an eSIM, e.g., a processor of the source wireless device obtains, from one or more applet asset servers, one or more subscription service files usable to generate a version of applets associated with the eSIM. The wireless device generates an eSIM export package that includes the eSIM and at least one of the one or more of the subscription service files. The processor of the source wireless device provides the eSIM export package to the target wireless device to use to install the transferred eSIM and one or more applets based on the subscription service files on the eUICC of the target wireless device.

### CROSS-REFERENCE TO RELATED APPLICATIONS

The present application claims the benefit of U.S. Provisional Application No. 63/596,561, entitled “CAP FILE MANAGEMENT FOR ESIM EXPORT,” filed Nov. 6, 2023, the content of which is incorporated by reference herein in its entirety for all purposes.

### FIELD

The described embodiments set forth techniques for managing subscription service files, such as Customized Applications for Mobile network Enhanced Logic (CAMEL) Application Part (CAP) files, for an electronic SIM (eSIM) transfer between wireless devices.

### BACKGROUND

Many mobile wireless devices are configured to use removable Universal Integrated Circuit Cards (UICCs) that enable the mobile wireless devices to access services provided by Mobile Network Operators (MNOs). In particular, each UICC includes at least a microprocessor and a read-only memory (ROM), where the ROM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a mobile wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles-also referred to herein as eSIMs-and can eliminate the need to include UICC-receiving bays in wireless devices. Applets associated with eSIMs can also be installed on the eUICC from subscription service files, such as CAP files, provided in a bound profile package (BPP) received from a provisioning server.

Mechanisms to transfer a cellular wireless service plan between wireless devices include i) physical transfer of a UICC (SIM card) from a source device to a target device and ii) and electronic transfer of an eSIM of an eUICC of a source wireless device to an eSIM on an eUICC of a target wireless device. Present procedures discard certain subscription service files associated with an eSIM, such as CAP files, after installation of applets associated with the eSIM on an eUICC completes. The absence of the subscription service files, such as CAP files, for applets associated with an eSIM hinders generation of an interoperable eSIM package to use for transfer of the eSIM from the eUICC of the source wireless device to the eUICC of the target wireless device. There exists a need for mechanisms to manage subscription service files, including CAP files, for eSIMs to use for eSIM management procedures.

### SUMMARY

This Application sets forth techniques for management of subscription service files, which can include Customized Applications for Mobile network Enhanced Logic (CAMEL) Application Part (CAP) files, of an electronic SIM (eSIM) for export and/or transfer from a wireless device. Subscription service files, such as CAP files, can be used to generate applets for installation with eSIM profiles on an embedded universal integrated circuit card (eUICC) of a wireless device. Upon installation on an eUICC of one or more applets associated with an eSIM of a wireless device, one or more subscription service files, such as CAP files, used to generate the one or more applets, can be encrypted by the eUICC and stored locally at the wireless device and/or remotely on a network-accessible server for later retrieval to use when generating an eSIM export package to transfer the eSIM from the eUICC of the wireless device to an eUICC of another wireless device. In some embodiments, as part of an eSIM export procedure to transfer an eSIM from an eUICC of a source wireless device to an eUICC of a target wireless device, a processor of the source wireless device obtains one or more subscription service files, which can include one or more CAP files, and provides the one or more subscription service files to the eUICC of the source wireless device. The eUICC of the source wireless device can combine the one or more subscription service files with eSIM profile information to generate an eSIM export package to provide to the eUICC of the target wireless device to use to install the transferred eSIM and one or more applets based on the subscription service files on the eUICC of the target wireless device. In some embodiments, the processor of the source wireless device obtains one or more of the subscription service files, e.g., one or more CAP files, from one or more applet asset servers for which network addresses, e.g., universal record locator (URL) values, can be obtained from the eUICC of the source wireless device or from a network-accessible applet asset discovery server. In some embodiments, the processor of the source wireless device obtains encrypted versions of the one or more of the subscription service files, which can include one or more CAP files, from local storage at the source wireless device or from network-accessible remote storage and provides the encrypted versions of the one or more subscription service files to the eUICC of the source wireless device to generate decrypted versions of the one or more subscription service files to include in the eSIM export package. The processor of the source wireless device can reference the subscription service files, e.g., when communicating with an applet asset discovery server and/or with one or more applet asset servers, based on application identifier (AID) values for applets associated with the subscription service files. In some embodiments, the processor of the source wireless device obtains, from the eUICC of the source wireless device, one or more AID values for applets associated with an eSIM to transfer to the eUICC of the target wireless device. In some embodiments, the eUICC of the source wireless device saves personalized applet data, e.g., per AID value corresponding to each applet, for an eSIM. In some embodiments, the eUICC of the source wireless device provides the personalized applet data to the eUICC of the target wireless device to use for personalizing the eSIM on the eUICC of the target wireless device. In some embodiments, the personalized applet data is included in (or with) the eSIM export package provided to the target wireless device, while in some embodiments, the personalized applet data is provided to the target wireless device separately from the eSIM export package.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIGS. 3A and 3B illustrate block diagrams of exemplary cellular service transfer mechanisms for wireless devices, according to some embodiments.

FIGS. 4A, 4B, and 4C illustrate exemplary sequences of actions performed to export and transfer an eSIM with CAP files associated with applets of the eSIM from a source wireless device to a target wireless device, according to some embodiments.

FIG. 5A illustrates a flowchart of an exemplary method performed by a source wireless device to transfer an eSIM with applets to a target wireless device, according to some embodiments.

FIG. 5B illustrates a flowchart of another exemplary method performed by a source wireless device to transfer an eSIM with applets to a target wireless device, according to some embodiments.

FIG. 5C illustrates a flowchart of an exemplary method performed by an applet asset server to assist in transfer of an eSIM with applets from a source wireless device to a target wireless device, according to some embodiments.

FIGS. 6A and 6B illustrate another exemplary sequence of actions performed to export and transfer and eSIM with CAP files associated with applets of the eSIM from a source wireless device to a target wireless device, according to some embodiments.

FIG. 7 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques for management of subscription service files, which can include Customized Applications for Mobile network Enhanced Logic (CAMEL) Application Part (CAP) files, of an electronic SIM (eSIM) for export and/or transfer from a wireless device. Subscription service files, such as CAP files, can be used to generate applets for installation with eSIM profiles on an embedded universal integrated circuit card (eUICC) of a wireless device. Present procedures discard one or more subscription service files, such as one or more CAP files, after installation of applets associated with an eSIM on an eUICC completes. The absence of subscription service files, e.g., CAP files, for applets associated with an eSIM hinders generation of an interoperable eSIM package to use for transfer of the eSIM from the eUICC of the source wireless device to the eUICC of the target wireless device. In some embodiments described in this Application, one or more subscription services files, such as one or more CAP files, can be re-used later as part of an eSIM procedure, e.g., an eSIM export procedure, to transfer the eSIM (and therefore associated applets) from a source wireless device to a target wireless device. Upon installation on an eUICC of one or more applets associated with an eSIM of a source wireless device, one or more subscription service files, such as one or more CAP files, used to generate the one or more applets, can be encrypted by the eUICC and stored locally at the source wireless device and/or remotely on a network-accessible server for later retrieval to use when generating an eSIM export package to transfer the eSIM from the eUICC of the source wireless device to an eUICC of the target wireless device.

In some embodiments, as part of an eSIM procedure, e.g., an eSIM export procedure, to transfer an eSIM from an eUICC of a source wireless device to an eUICC of a target wireless device, a processor of the source wireless device external to the eUICC of the source wireless device obtains one or more subscription service files, e.g., one or more CAP files, and provides the one or more subscription service files, e.g., one or more CAP files, to the eUICC of the source wireless device. The eUICC of the source wireless device can combine the one or more subscription service files, which can include one or more CAP files, with eSIM profile information to generate an eSIM export package to provide to the eUICC of the target wireless device to use to install the transferred eSIM on the eUICC of the target wireless device. In some embodiments, the processor of the source wireless device obtains one or more of the subscription service files, e.g., one or more CAP files, from one or more applet asset servers for which network addresses, e.g., universal record locator (URL) values, can be obtained from the eUICC of the source wireless device or from a network-accessible applet asset discovery server. In some cases, a subscription service file, such as a CAP file, obtained from an applet asset server can correspond to an updated (e.g., current, newer) version of an applet installed with an eSIM on the eUICC of the source wireless device. In some cases, a subscription service file, e.g., a CAP file, obtained from an applet server can correspond to a version of an applet as installed with the eSIM on the eUICC of the source wireless device (e.g., as originally installed or as presently installed at the time of generating the eSIM export package to transfer the eSIM associated with the applet). In some embodiments, the processor of the source wireless device obtains encrypted versions of one or more of the subscription service files, which can include one or more CAP files, from local storage at the source wireless device or from network-accessible remote storage and provides the encrypted versions of the one or more subscription service files, which can include one or more CAP files, to the eUICC of the source wireless device to generate decrypted versions of the one or more subscription service files, e.g., one or more CAP files, to include in the eSIM export package. In some cases, the processor provides to the eUICC of the source wireless device one or more subscription service files, e.g., one or more CAP files, from local storage and/or remote storage and one or more subscription service files, e.g., one or more CAP files, from one or more applet asset servers. The eUICC of the source wireless device can generate an eSIM export package that includes none, some, or all of the one or more subscription service files, which can include one or more CAP files, obtained by the processor from various sources.

The processor of the source wireless device can reference the subscription service files, which can include one or more CAP files, e.g., when communicating with an applet asset discovery server and/or with one or more applet asset servers, based on application identifier (AID) values for applets associated with the one or more subscription service files, e.g., one or more CAP files. In some embodiments, the processor of the source wireless device obtains, from the eUICC of the source wireless device, one or more AID values for applets associated with an eSIM to transfer to the eUICC of the target wireless device. The one or more AID values can be provided as an array by the eUICC responsive to a request for applet assert server information, which can include a network address, e.g. URL value, for each applet asset server associated with an applet identified by an AID value in the array. In some embodiments, the processor of the source wireless device establishes an individual, authenticated session with an applet asset server to obtain one or more subscription service files, e.g., one or more CAP files, for applets identified by AID values and associated with the applet asset server. In some embodiments, the processor of the source wireless device establishes separate authenticated sessions with multiple applet asset servers, e.g., with each applet asset server identified in the array obtained from the eUICC. In some embodiments, the eUICC provides to the processor of the source wireless device an array of AID values for applets associated with an eSIM responsive to a request for applet asset server information along with an applet asset discovery server network address, e.g., URL value, for an applet asset discovery server from which to obtain network addresses for the applet asset servers associated with the AID values. The processor of the source wireless device can obtain from the applet asset discovery server the network addresses responses to a request that includes one or more of the AID values.

The processor of the source wireless device provides, to the eUICC of the source wireless device, one or more subscription service files, e.g., one or more CAP files, which can be unencrypted versions of one or more subscription service files, e.g., one or more CAP files, obtained from one or more applet asset servers and/or encrypted versions of one or more subscription service files, e.g., one or more CAP files, obtained from local storage and/or remote storage. The eUICC of the source wireless device can merge the one or more subscription service files, which can include one or more CAP files, with eSIM profile information to form an eSIM export package to be sent to the eUICC of the target wireless device for installation of the eSIM profile along with associated applets (which can be generated using the one or more subscription service files, such as one or more CAP files). In some embodiments, the eUICC of the source wireless device saves personalized applet data, e.g., per AID value corresponding to each applet, for an eSIM. In some embodiments, the eUICC of the source wireless device provides the personalized applet data to the eUICC of the target wireless device to use for personalizing the eSIM on the eUICC of the target wireless device. In some embodiments, the personalized applet data is included in (or with) the eSIM export package provided to the target wireless device, while in some embodiments, the personalized applet data is provided to the target wireless device separately from the eSIM export package.

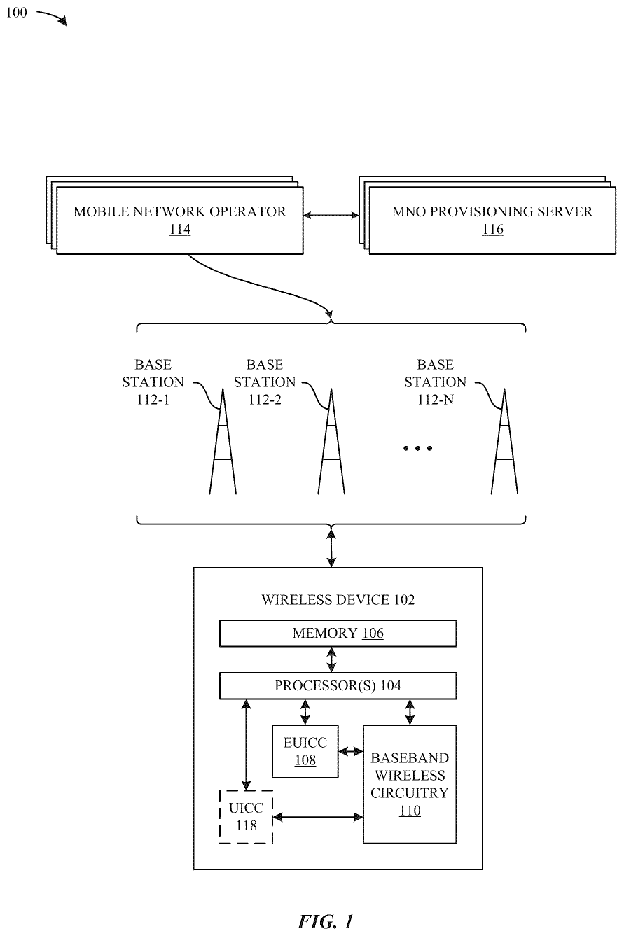

These and other embodiments are discussed below with reference to FIGS. 1-6; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a wireless device, a mobile device, a user equipment (UE) and the like, a group of base stations 112-1 to 112-N that are managed by different Mobile Network Operators (MNOs) 114, and a set of MNO provisioning servers 116 that are in communication with the MNOs 114. Additional MNO infrastructure servers, such as used for account management and billing are not shown. The wireless device 102 can represent a mobile computing device (e.g., a phone, a tablet, a peripheral device, etc.), the base stations 112-1 to 112-n can represent cellular radio access network (RAN) entities including evolved NodeBs (eNodeBs or eNBs) and/or next generation NodeBs (gNodeBs or gNB) that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs), etc.). The MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108 and/or an integrated UICC (iUICC) (not shown), and a baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 118, also referred to as Subscriber Identity Module (SIM) cards, in addition to the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband wireless circuitry 110, and UICC 118) can be arranged and combined in any number of configurations. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO, an eSIM can downloaded to and installed on the eUICC 108. In some embodiments, the eUICC 108 obtains one or more eSIMs from one or more associated MNO provisioning servers 116. The MNO provisioning servers 116 can be maintained by the MNOs 114, an OEM manufacturer, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

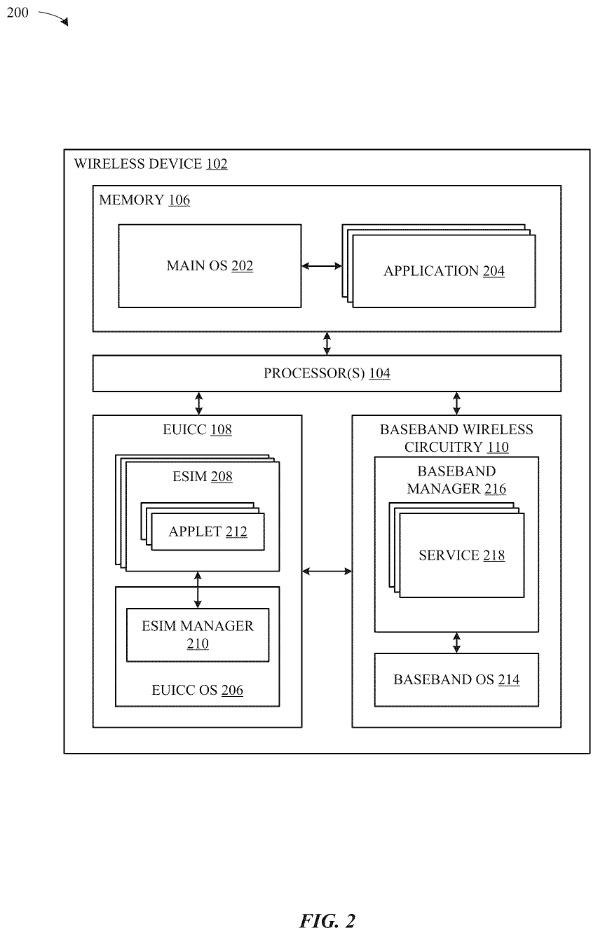

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and to provide baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102. The applets 212 for an eSIM 208 can be installed on the eUICC 108 from one or more subscription service files, such as one or more Customized Applications for Mobile network Enhanced Logic (CAMEL) Application Part (CAP) files, which can be included in a bound profile package (BPP) for the eSIM 208 obtained from an MNO provisioning server 116. As discussed further herein, subscription service files, such as CAP files, can be retained after installation of the applets 212 or obtained from applet asset servers to use for installing anew, re-installing, and/or updating applets 212.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

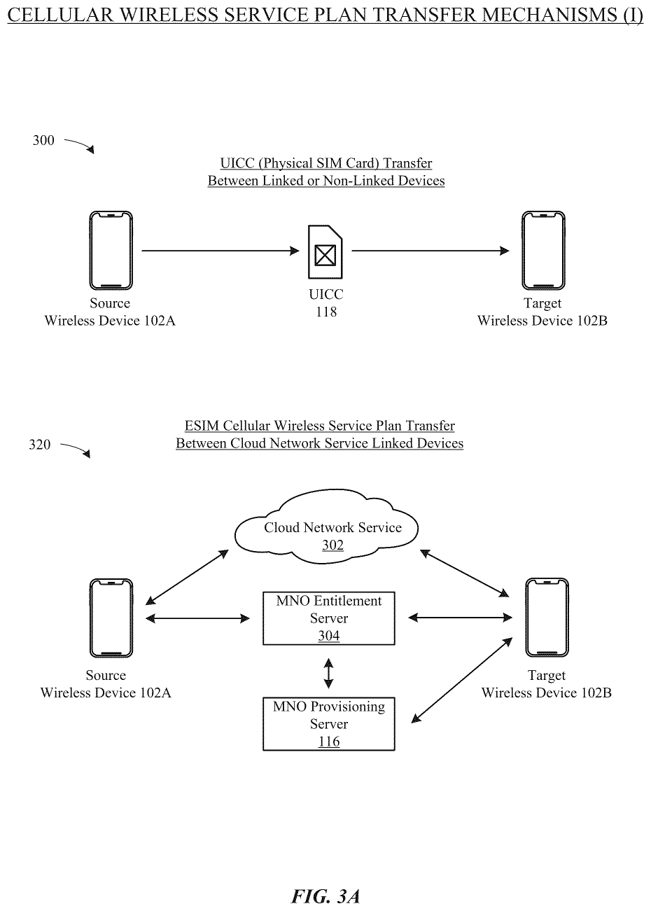

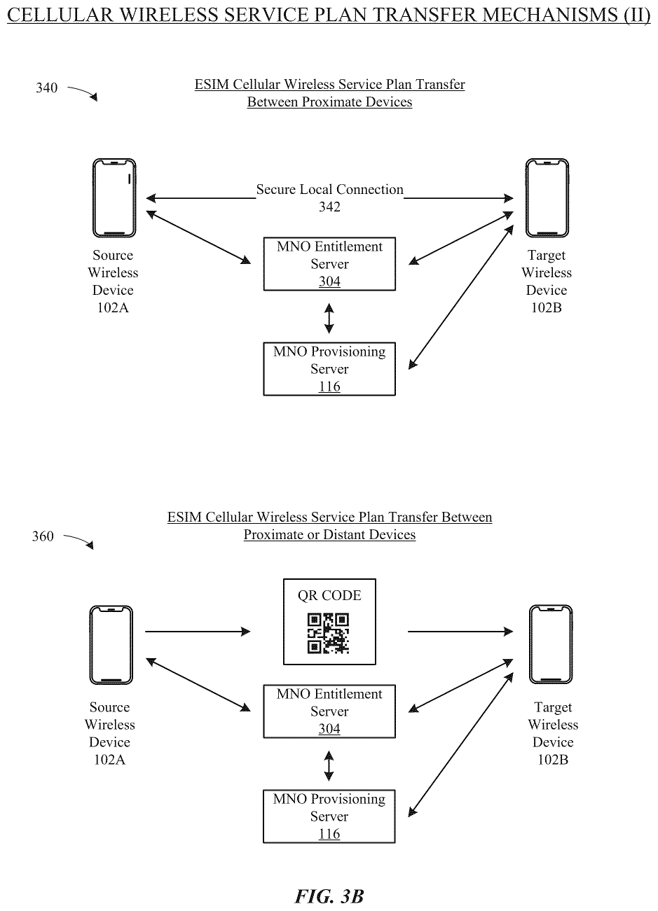

FIG. 3A illustrates diagrams 300, 320 of two exemplary mechanisms to transfer a cellular wireless service plan from a source wireless device 102A to a target wireless device 102B. In diagram 300, a cellular wireless service plan is associated with a UICC (SIM card) 118 that includes credentials for access to wireless networks of an MNO 114. When the target wireless device 102B supports hardware and software capabilities required to access wireless networks of an MNO 114 using a SIM in the UICC 118, a user can remove the UICC 118 from the source wireless device 102A and insert the UICC 118 into a receiving bay of the target wireless device 102B. The target wireless device 102B can use credentials included in the SIM of the UICC 118 to authenticate with and camp on a cellular wireless access network associated with the MNO 114 associated with the SIM of the UICC 118. The source wireless device 102A and the target wireless device 102B can belong to distinct users and can be supplied by different original equipment manufacturers (OEMs). Applets 212 associated with the SIM of the UICC 118 also can be stored on the UICC 118 and transfer with the SIM from the source wireless device 102A to the target wireless device 102B.

Diagram 320 illustrates an exemplary mechanism to transfer a cellular wireless service plan, associated with an eSIM 208 on an eUICC 108, from a source wireless device 102A to a target wireless device 102B using a cloud network service 302. Unlike the mechanism illustrated in diagram 300, physical transfer of a UICC 118 does not occur, and in some cases a new eSIM 208 can be provided to an eUICC 108 of the target wireless device 102B as part of the transfer. If a new eSIM 208 is downloaded from an MNO provisioning server 116, then CAP files for installation of applets 212 can also be provided by the MNO provisioning server 116 in a BPP that includes the new eSIM 208. In some cases, each of the source wireless device 102A and the target wireless device 102B can be registered with a common user account, such as managed by a cloud-based service, e.g., an iCloud® service account. The source wireless device 102A can provide information regarding cellular wireless service plans available on the source wireless device 102A to the cloud network service 302, and the target wireless device 102B can discover available cellular wireless service plans based on the information stored at the cloud network service 302. The source wireless device 102A can obtain from the MNO entitlement server 304 a transfer token required for transfer of a cellular wireless service plan associated with an eSIM 208. The target wireless device 102B can obtain an eSIM 208 from the MNO provisioning server 116, which can be authorized to release the eSIM 208 to the target wireless device 102B based on communication from the MNO entitlement server 304. The target wireless device 102B can download, install, and activate the eSIM 208 on an eUICC 108 of the target wireless device 102B. The transfer mechanism illustrated by the diagram 320 requires, however, that the source wireless device 102A and the target wireless device 102B be linked by a common user account at the cloud network service 302 and that a new eSIM 208 be downloaded from the MNO provisioning server 116.

FIG. 3B illustrates diagrams 340, 360 of additional exemplary mechanisms to transfer a cellular wireless service plan associated with an eSIM 208 from a source wireless device 102A to a target wireless device 102B, where the source and target wireless devices 102A, 102B are not required to be linked to a common user account of a cloud network-based service or to be manufactured by a common OEM. As illustrated by diagram 340, the source wireless device 102A and the target wireless device 102B can establish a secure local connection 342 between them over which to exchange information required to select and transfer a cellular wireless service plan, associated with a SIM on a UICC 118 or an eSIM 208 on an eUICC 108 of the source wireless device 102A, to a new eSIM 208 downloaded to an eUICC 108 of the target wireless device 102B. In some embodiments, as illustrated in diagram 360, the source wireless device 102A can provide information for transfer of the cellular wireless service plan to the target wireless device 102B using a quick response (QR) code, which can be scanned by the target wireless device 102B. In some embodiments, the source and target wireless devices 102A, 102B are within proximity of each other to allow display of the QR code on the source wireless device 102A and scanning by a camera of the target wireless device 102B. In some embodiments, the source and target wireless devices 102A, 102B are not within proximity of each other, and the source wireless device 102A provides the QR code to the target wireless device 102B via an alternative out-of-band communication channel (not shown), such as via email or via a message service. In either mechanism (secure Bluetooth or QR code), each of the source wireless device 102A and the target wireless device 102B can communicate with an MNO entitlement server 304 to authorize transfer of the cellular wireless service plan from the source wireless device 102A to the target wireless device 102B. The MNO entitlement server 304 can communicate information to the MNO provisioning server 116 to reserve a new eSIM 208 for the transferred cellular wireless service plan. The target wireless device 102B can download the new eSIM 208 from the MNO provisioning server 116 and subsequently install and activate the new eSIM 208 on an eUICC 108 of the target wireless device 102B. In some embodiments, the source and target wireless devices 102A, 102B need to be within a threshold proximity distance of each other in order to establish the secure Bluetooth communication channel. In some embodiments, the source wireless device 102A and the target wireless device 102B can use different operating systems and can be manufactured by different OEMs, e.g., an iOS device manufactured by Apple Inc. and an Android™M device manufactured by Motorola.

The transfer mechanisms illustrated in FIGS. 3A and 3B rely on downloading a new eSIM 208 from an MNO provisioning server 116, which can include one or more subscription service files, such as CAP files, for installation of applets 212 for the new eSIM 208. In some cases, however, it is preferable to have the source wireless device 102A generate an eSIM export package that includes an eSIM profile and one or more subscription service files, such as CAP files, for installation of applets 212 associated with the eSIM profile being transferred and provide the eSIM export package to the target wireless device 102B for installation of the transferred eSIM profile and associated applets 212 on the eUICC 108 of the target wireless device 102B. Presently, subscription service files, such as CAP files, used to install (or to update) applets 212 for an eSIM 208 on an eUICC 108 are discarded after installing the applets 212. Regenerating the subscription service files, e.g., one or more CAP files, from installed applets 212 for an eSIM 208 is infeasible. Instead, as described herein, subscription service files, e.g., CAP files, can be retained after installation of applets 212 or reacquired from applet asset servers by a source wireless device 102A to use for generation of a complete eSIM export package to transfer an eSIM 208 to a target wireless device 102B. Transfer of the eSIM export package can occur via various mechanisms, such as via a secure local connection 342, via a cloud network service 302, encoded via a QR code, or via another secure transfer between the source wireless device 102A and the target wireless device 102B. In some embodiments, an eSIM 208 can be installed on an eUICC 108B of the target wireless device 102B without requiring download of a new eSIM 208 from an MNO provisioning server 116.

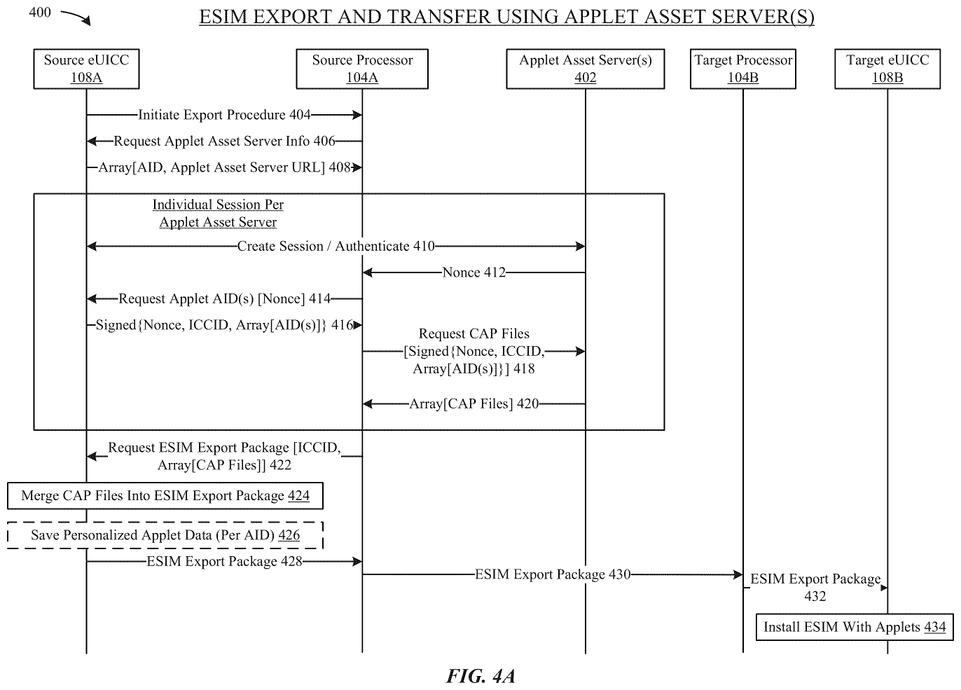

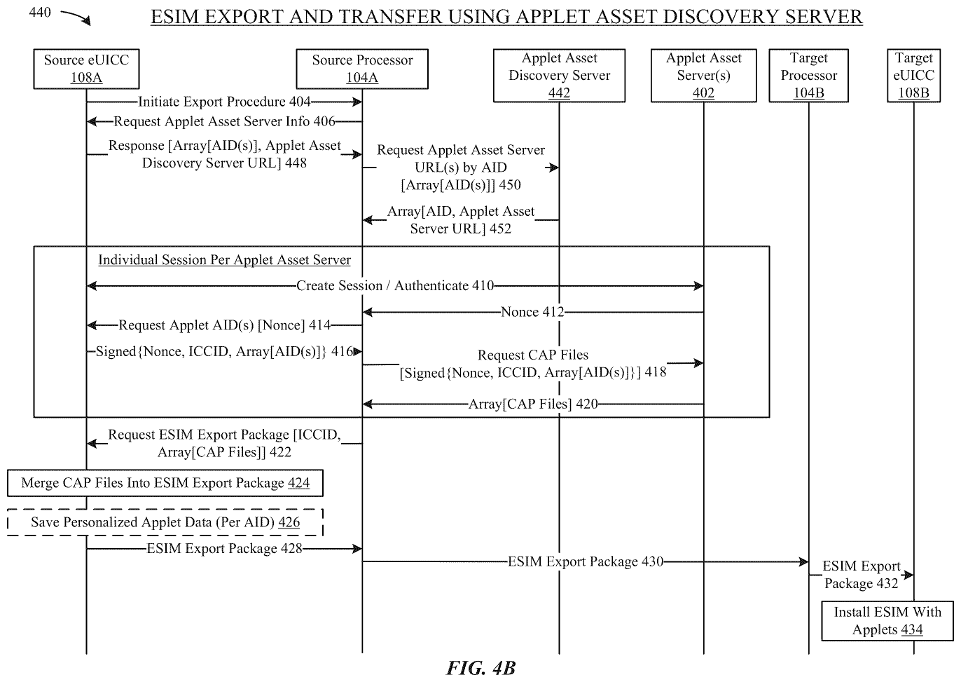

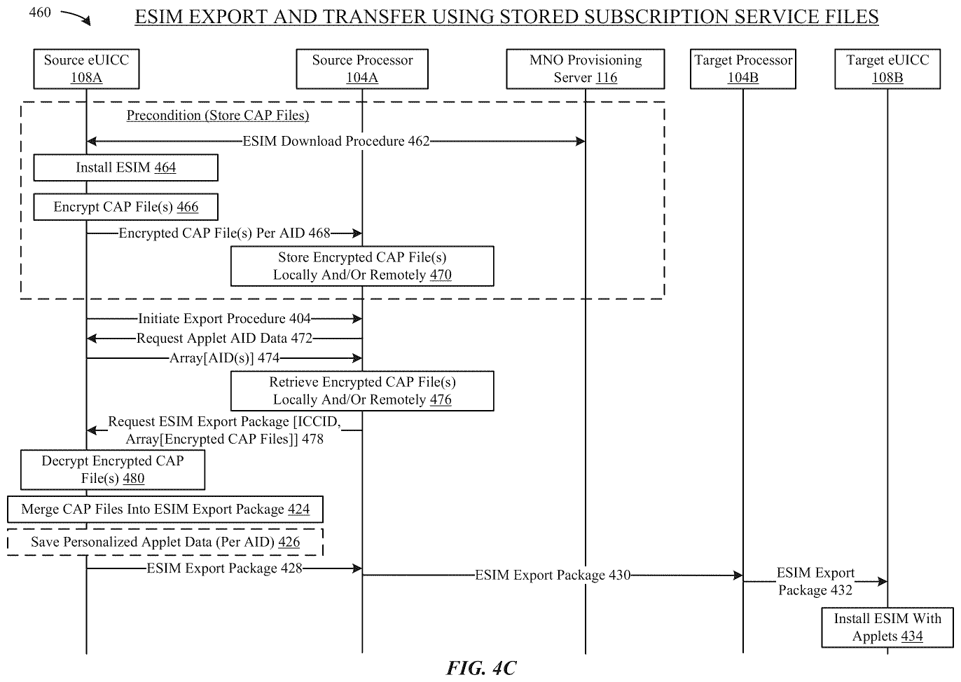

FIG. 4A illustrates a diagram 400 of an exemplary sequence of actions performed to export and transfer an eSIM 208 along with subscription service files, e.g., CAP files, associated with applets 212 of the eSIM 208 from a source wireless device 102A to a target wireless device 102B. At 404, an eUICC 108A of the source wireless device 102A can send a message to a processor 104A of the source wireless device 102A to initiate a procedure to transfer an eSIM 208 from the eUICC 108A of the source wireless device 102A to an eUICC 108B of the target wireless device 102B. The processor 104A of the source wireless device 102A can respond, at 406, by sending a message to the eUICC 108A of the source wireless device 102A to obtain applet assert server information for applets 212 associated with the eSIM 208 to be transferred. The eUICC 108A of the source wireless device 102A can determine the applets 212 associated with the eSIM 208 to be transferred, where each applet can be identified by an application identifier (AID) value, and respond to the processor 104A of the source wireless device 102A by sending, at 408, a message that includes an array of one or more AID values and one or more network addresses, e.g., URL values, for applet asset servers 402 from which to obtain subscription service files, e.g., CAP files, to use to generate a version of the applets 212 associated with the eSIM 208 to be transferred. In some embodiments, the processor 104A of the source wireless device 102A can retrieve subscription service files, e.g., CAP files, for the eSIM 208 to be transferred from a single applet asset server 402. In some embodiments, the processor 104A of the source wireless device 102A can retrieve subscription service files, e.g., CAP files, for the eSIM 208 to be transferred from multiple, distinct applet asset servers 402.

For each applet asset server 402, at 410, a secure, authenticated session can be established by the eUICC 108A of the source wireless device 102A between the source wireless device 102A and the applet asset server 402. When subscription service files, e.g., CAP files, for applets 212 of the eSIM 208 to be transferred are distributed among multiple applet asset servers 402, the source wireless device 102A can establish individual secure, authenticated sessions with each applicable applet asset server 402. The applet asset server 402, at 412, can provide to the processor 104A of the source wireless device 102A with a nonce, which the processor 104A of the source wireless device 102A, at 414, can provide to the eUICC 108A of the source wireless device 102A in a message requesting AID values for applets 212 associated with the eSIM 208 to be transferred. The eUICC 108A of the source wireless device 102A responds, at 416, by sending to the processor 104A of the source wireless device 102A a message, signed by the eUICC 108A, that includes the nonce received from applet asset server 402, a unique identifier for the eSIM 208 to be transferred, e.g., an international circuit card identifier (ICCID) value, and an array of one or more AID values. The processor 104A of the source wireless device 102A, at 418, sends to the applet asset server 402 a message requesting subscription service files, e.g., CAP files, for applets 212 identified by the array of one or more AID values, the message including the signed message received from the eUICC 108A at 416. The applet asset server 402, at 420, replies to the request with a message that includes an array of one or more subscription service files, e.g., one or more CAP files, for the applets 212 identified by the array of one or more AID values. In some embodiments, the some embodiments, the applet asset server 402 may respond with a subscription service file, e.g., a CAP file, for a newer version of an applet that is associated with the eSIM 208 to be transferred. In some embodiments, the applet asset server 402 may respond with a subscription service file, e.g., a CAP file, for an entirely new applet to be used with the eSIM 208 to be transferred. In some embodiments, the applet asset server 402 may respond with a subscription service file, e.g., a CAP file, to replicate a version of the applet for the eSIM 208 to be transferred, e.g., as installed originally with the eSIM 208 on the eUICC 108A of the source wireless device 102A or as presently installed for the eSIM 208 to be transferred. In some embodiments, the applet asset server 402 may respond without providing a subscription service file, e.g., a CAP file, for an AID value indicated in the array of one or more AID values.

The processor 104A of the source wireless device 102A provides, at 422, a message to the eUICC 108A of the source wireless device 102A requesting an eSIM export package to encapsulate the eSIM 208 to be transferred with subscription service files, e.g., CAP files, for applets 212 associated with the eSIM 208. The message can include an ICCID value for the eSIM 208 and an array of one or more subscription service files, e.g., one or more CAP files, to be used for generation of applets 212 associated with the eSIM 208, e.g., at the eUICC 108B of the target wireless device 102B. At 424, the eUICC 108A of the source wireless device 102A merges the subscription service files, e.g., one or more CAP files, obtained from the processor 104A of the source wireless device 102A with eSIM profile data to form an eSIM export package. The eSIM export package can include one or more subscription service files, e.g., one or more CAP files, to use to generate applets 212 at the eUICC 108B of the target wireless device 102B when installing the eSIM 208 on the eUICC 108 of the target wireless device 102B. In some embodiments, at 426, the eUICC 108A of the source wireless device 102A saves personalized applet data for one or more applets 212, e.g., for each applet identifier by an AID value. In some embodiments, the personalized applet data can be transferred to the target wireless device 102B to use for personalizing the applets 212 generated by the one or more subscription service files, e.g., one or more CAP files, in association with installation of the eSIM at the eUICC 108B of the target wireless device 102B. The eUICC 108A of the source wireless device 102A, at 428, provides the eSIM export package to the processor 104A of the source wireless device 102A, which forwards the eSIM export package, at 430, to the processor 104B of the target wireless device 102B to provide to the eUICC 108B of the target wireless device 102B at 432. At 434, the eUICC 108B of the target wireless device 102B can install the eSIM 208 and associated applets 212, e.g., using the provided subscription service files, e.g., one or more CAP files, included in the eSIM export package. In some embodiments, the applets 212 are personalized by the eUICC 108B of the target wireless device 102B based on personalized applet data for the applets 212 obtained from the eUICC 108A of the source wireless device 102A.

FIG. 4B illustrates a diagram 440 another exemplary sequence of actions performed to export and transfer an eSIM 208 along with subscription service files, e.g., CAP files, associated with applets 212 of the eSIM 208 from a source wireless device 102A to a target wireless device 102B. In FIG. 4A, the processor 104A of the source wireless device 102A obtains network addresses, e.g., URL values, for one or more applet asset servers 402 from the eUICC 108A of the source wireless device 102A. In FIG. 4B, the processor 104A of the source wireless device 102A obtains a network address, e.g., a URL value, for an applet asset discovery server 442, which is simpler for the eUICC 108A of the source wireless device 102A to maintain, and the processor 104A of the source wireless device 102A obtains network addresses, e.g., URL values, for one or more applet asset servers 402 from the applet asset discovery server 442, which can serve as a common resource from which to obtain applet asset server 402 information for multiple source wireless devices 102A.

At 404, the eUICC 108A of the source wireless device 102A can send a message to the processor 104A of the source wireless device 102A to initiate a procedure to transfer an eSIM 208 from the eUICC 108A of the source wireless device 102A to an eUICC 108B of the target wireless device 102B. The processor 104A of the source wireless device 102A can respond, at 406, by sending a message to the eUICC 108A of the source wireless device 102A to obtain applet assert server information for applets 212 associated with the eSIM 208 to be transferred. The eUICC 108A of the source wireless device 102A can determine the applets 212 associated with the eSIM 208 to be transferred, where each applet can be identified by an application identifier (AID) value, and respond to the processor 104A of the source wireless device 102A by sending, at 448, a message that includes an array of one or more AID values and a network address, e.g., a URL value, for an applet asset discovery server 442 to use to obtain one or more network addresses, e.g., URL values, for applet asset servers 402 from which to obtain subscription service files, e.g., CAP files, to use to generate a version of the applets 212 associated with the eSIM 208 to be transferred. The processor 104A of the source wireless device 102A, at 450, sends to the applet asset discovery server 442 a request for network addresses, e.g., URL values, for one or more applet asset servers 402 from which to obtain subscription service files, e.g., CAP files, with which to generate applets 212 identified by the one or more AID values. The request can include an array of the one or more AID values. The applet asset discovery server 442 can respond, at 452, with a message that includes the one or more AID values, each AID value paired with a corresponding network address, e.g., URL value, for an applet asset server 402 from which to obtain CAP files with which to generate applets 212 identified by AID values. In some embodiments, the processor 104A of the source wireless device 102A can retrieve subscription service files, e.g., CAP files, for the eSIM 208 to be transferred from a single applet asset server 402. In some embodiments, the processor 104A of the source wireless device 102A can retrieve subscription service files, e.g., CAP files, for the eSIM 208 to be transferred from multiple, distinct applet asset servers 402.

For each applet asset server 402, at 410, a secure, authenticated session can be established by the eUICC 108A of the source wireless device 102A between the source wireless device 102A and the applet asset server 402. When subscription service files, e.g., CAP files, for applets 212 of the eSIM 208 to be transferred are distributed among multiple applet asset servers 402, the source wireless device 102A can establish individual secure, authenticated sessions with each applicable applet asset server 402. The applet asset server 402, at 412, can provide to the processor 104A of the source wireless device 102A with a nonce, which the processor 104A of the source wireless device 102A, at 414, can provide to the eUICC 108A of the source wireless device 102A in a message requesting AID values for applets 212 associated with the eSIM 208 to be transferred. The eUICC 108A of the source wireless device 102A responds, at 416, by sending to the processor 104A of the source wireless device 102A a message, signed by the eUICC 108A, that includes the nonce received from applet asset server 402, a unique identifier for the eSIM 208 to be transferred, e.g., an international circuit card identifier (ICCID) value, and an array of one or more AID values. The processor 104A of the source wireless device 102A, at 418, sends to the applet asset server 402 a message requesting subscription service files, e.g., CAP files, for applets 212 identified by the array of one or more AID values, the message including the signed message received from the eUICC 108A at 416. The applet asset server 402, at 420, replies to the request with a message that includes an array of one or more subscription service files, e.g., one or more CAP files, for the applets 212 identified by the array of one or more AID values. In some embodiments, the some embodiments, the applet asset server 402 may respond with a subscription service file, e.g., a CAP file, for a newer version of an applet that is associated with the eSIM 208 to be transferred. In some embodiments, the applet asset server 402 may respond with a subscription service file, e.g., a CAP file, for an entirely new applet to be used with the eSIM 208 to be transferred. In some embodiments, the applet asset server 402 may respond with a subscription service file, e.g., a CAP file, to replicate a version of the applet for the eSIM 208 to be transferred, e.g., as installed originally with the eSIM 208 on the eUICC 108A of the source wireless device 102A or as presently installed for the eSIM 208 to be transferred. In some embodiments, the applet asset server 402 may respond without providing a subscription service file, e.g., a CAP file, for an AID value indicated in the array of one or more AID values.

The processor 104A of the source wireless device 102A provides, at 422, a message to the eUICC 108A of the source wireless device 102A requesting an eSIM export package to encapsulate the eSIM 208 to be transferred with subscription service files, e.g., CAP files, for applets 212 associated with the eSIM 208. The message can include an ICCID value for the eSIM 208 and an array of one or more subscription service files, e.g., one or more CAP files, to be used for generation of applets 212 associated with the eSIM 208, e.g., at the eUICC 108B of the target wireless device 102B. At 424, the eUICC 108A of the source wireless device 102A merges the subscription service files, e.g., CAP files, obtained from the processor 104A of the source wireless device 102A with eSIM profile data to form an eSIM export package. The eSIM export package can include one or more subscription service files, e.g., one or more CAP files, to use to generate applets 212 at the eUICC 108B of the target wireless device 102B when installing the eSIM 208 on the eUICC 108 of the target wireless device 102B. In some embodiments, at 426, the eUICC 108A of the source wireless device 102A saves personalized applet data for one or more applets 212, e.g., for each applet identifier by an AID value. In some embodiments, the personalized applet data can be transferred to the target wireless device 102B to use for personalizing the applets 212 generated by the subscription service files, e.g., CAP files, in association with installation of the eSIM at the eUICC 108B of the target wireless device 102B. The eUICC 108A of the source wireless device 102A, at 428, provides the eSIM export package to the processor 104A of the source wireless device 102A, which forwards the eSIM export package, at 430, to the processor 104B of the target wireless device 102B to provide to the eUICC 108B of the target wireless device 102B at 432. At 434, the eUICC 108B of the target wireless device 102B can install the eSIM 208 and associated applets 212, e.g., using the provided subscription service files, e.g., CAP files, included in the eSIM export package. In some embodiments, the applets 212 are personalized by the eUICC 108B of the target wireless device 102B based on personalized applet data for the applets 212 obtained from the eUICC 108A of the source wireless device 102A.

FIG. 4C illustrates a diagram 460 of another exemplary sequence of actions performed to export and transfer an eSIM 208 along with subscription service files, e.g., CAP files, associated with applets 212 of the eSIM 208 from a source wireless device 102A to a target wireless device 102B. In FIGS. 4A and 4B, the source wireless device 102A obtains one or more subscription service files, e.g., one or more CAP files, from one or more applet asset servers 402. In FIG. 4C, the source wireless device 102A obtains from local storage or from remote storage one or more subscription service files, e.g., one or more CAP files, previously received, e.g., from an MNO provisioning server 116 during installation of the eSIM 208 to be transferred and/or used for updating an applet (or customizing an eSIM 208) after installation of the eSIM 208 on the eUICC 108A of the source wireless device 102A.

At 462, the eUICC 108A of the source wireless device 102A performs a procedure to download an eSIM 208 from an MNO provisioning server 116. The eSIM 208 can be received as a bound profile package (BPP) that can include one or more subscription service files, e.g., one or more CAP files, for installation of applets 212 associated with the eSIM 208 on the eUICC 108A of the source wireless device 102A. At 464, the eUICC 108A installs the eSIM 208 and one or more applets 212 generated by execution of one or more subscription service files, e.g., one or more CAP files, included with the eSIM 208 obtained from the MNO provisioning server 116. Unlike present, customary procedures, the eUICC 108A of the source wireless device 102A, at 466, encrypts the one or more subscription service files, e.g., one or more CAP files,, and at 468 provides the encrypted one or more subscription service files, e.g., one or more CAP files,, at 468, to the processor 104A of the source wireless device 102A. The encrypted one or more subscription service files, e.g., one or more CAP files, can be referenced according to AID values for applets 212 that can be generated by the respective subscription service files, e.g., CAP files. At 470, the processor 104A of the source wireless device 102A stores the encrypted one or more subscription service files, e.g., one or more CAP files, locally at the source wireless device 102A and/or remotely at network-accessible storage, e.g., securely in a cloud network service 302 or other secure remote storage. The encrypted subscription service files, e.g., encrypted CAP files, can later be used when exporting the eSIM 208 to the target wireless device 102B.

At 404, the eUICC 108A of the source wireless device 102A can send a message to the processor 104A of the source wireless device 102A to initiate a procedure to transfer an eSIM 208 from the eUICC 108A of the source wireless device 102A to an eUICC 108B of the target wireless device 102B. At 472, the processor 104A of the source wireless device 102A responds with a request for applet AID data, e.g., AID values for applets 212 associated with the eSIM 208 to be transferred. At 474, the eUICC 108A of the source wireless device 102A responds with an array of one or more AID values for the applets 212 associated with the eSIM 208. At 476, the processor 104A of the source wireless device 102A retrieves one or more encrypted subscription service files, e.g., one or more encrypted CAP files, from local storage and/or from network-accessible remote storage, where the one or more AID values can be used to identify the applicable encrypted subscription service files, e.g., applicable encrypted CAP files, for the applets 212 of the eSIM 208. At 478, the processor 104A of the source wireless device 102A provides to the eUICC 108A of the source wireless device 102A a message requesting an eSIM export package for the eSIM 208 to be transferred. The message can include a unique identifier value, e.g., an ICCID value, for the eSIM 208, and an array of one or more encrypted subscription service files, e.g., one or more encrypted CAP files, for applets 212 associated with the eSIM 208.

At 480, the eUICC 108A of the source wireless device 102A decrypts the encrypted one or more subscription service files, e.g., one or more encrypted CAP files. At 424, the eUICC 108A of the source wireless device 102A merges the decrypted versions of the subscription service files, e.g., CAP files, with eSIM profile data to form an eSIM export package. The eSIM export package can include one or more subscription service files, e.g., CAP files, to use to generate applets 212 at the eUICC 108B of the target wireless device 102B when installing the eSIM 208 on the eUICC 108 of the target wireless device 102B. In some embodiments, at 426, the eUICC 108A of the source wireless device 102A saves personalized applet data for one or more applets 212, e.g., for each applet identifier by an AID value. In some embodiments, the personalized applet data can be transferred to the target wireless device 102B to use for personalizing the applets 212 generated by the subscription service files, e.g., CAP files, in association with installation of the eSIM at the eUICC 108B of the target wireless device 102B. The eUICC 108A of the source wireless device 102A, at 428, provides the eSIM export package to the processor 104A of the source wireless device 102A, which forwards the eSIM export package, at 430, to the processor 104B of the target wireless device 102B to provide to the eUICC 108B of the target wireless device 102B at 432. At 434, the eUICC 108B of the target wireless device 102B can install the eSIM 208 and associated applets 212, e.g., using the provided subscription service files, e.g., CAP files, included in the eSIM export package. In some embodiments, the applets 212 are personalized by the eUICC 108B of the target wireless device 102B based on personalized applet data for the applets 212 obtained from the eUICC 108A of the source wireless device 102A.

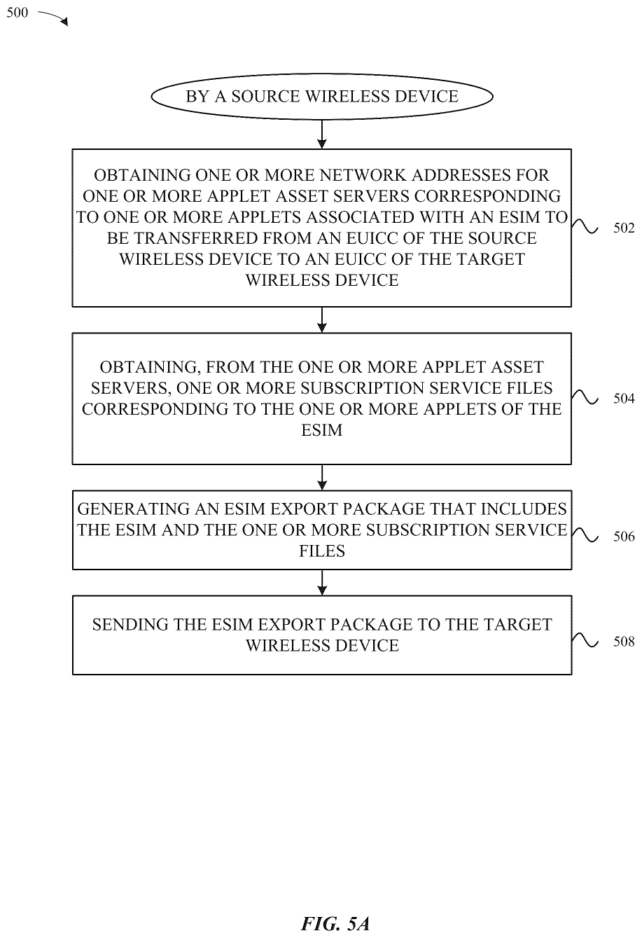

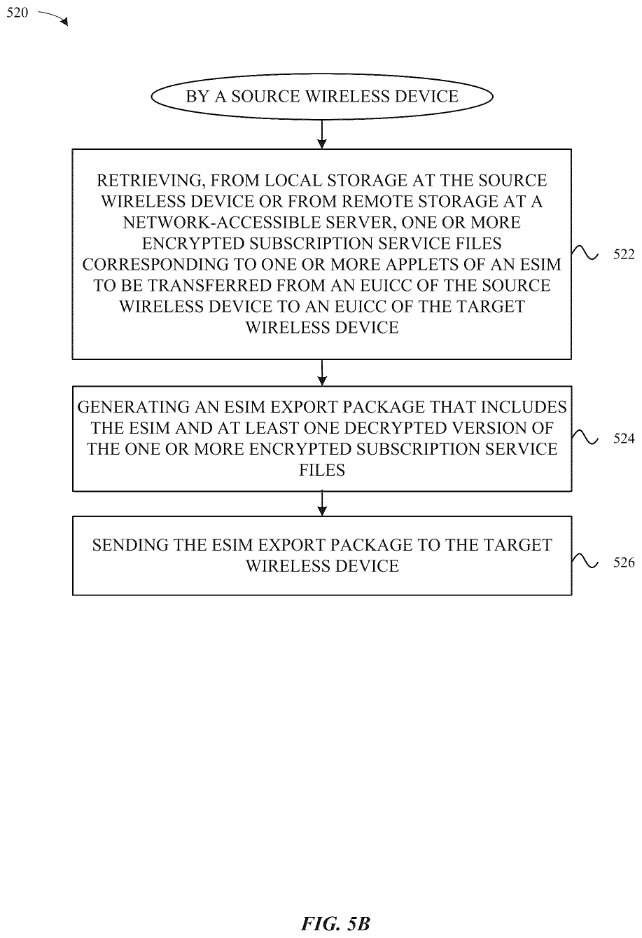

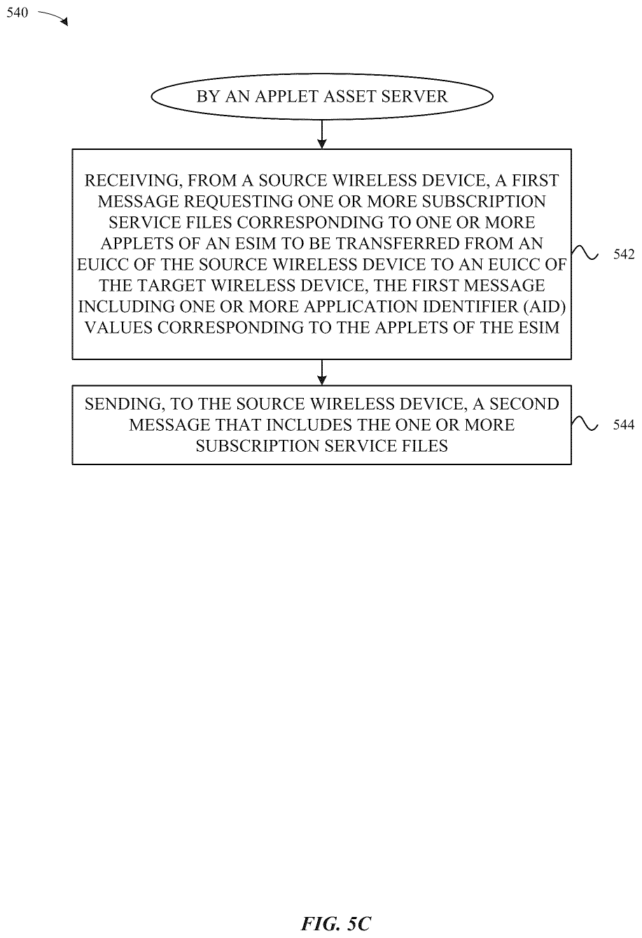

FIG. 5A illustrates a flowchart 500 of an exemplary method performed by a source wireless device 102A to transfer an eSIM 208 with applets 212 to a target wireless device 102B. At 502, a processor 104A of the source wireless device 102A obtains one or more network addresses, e.g., URL values, for one or more applet asset servers 402 corresponding to one or more applets 212 associated with the eSIM 208 to be transferred from an eUICC 108A of the source wireless device 102A to an eUICC 108B of the target wireless device 102B. At 504, the processor 104A of the source wireless device 102A obtains, from the one or more applet asset servers 402, one or more subscription service files corresponding to the one or more applets 212 of the eSIM 208. At 506, the processor 104A of the source wireless device 102A generates an eSIM export package that includes the eSIM 208 and the one or more subscription service files. At 508, the processor 104A of the source wireless device 102A sends the eSIM export package to the target wireless device 102B.

In some embodiments, the processor of the source wireless device 102A is external to the eUICC 108A of the source wireless device 102A. In some embodiments, the processor of the source wireless device 102A is integrated with the eUICC 108A of the source wireless device 102A. In some embodiments, the function of the eUICC 108A of the source wireless device is integrated into the processor of the source wireless device 102A. In some embodiments, the processor 104A of the source wireless device 102A generates the eSIM export package in conjunction with, e.g., with the assistance of, the eUICC 108A of the source wireless device 102A.

In some embodiments, at least one of the one or more subscription service files include a Customized Applications for Mobile network Enhanced Logic (CAMEL) Application Part (CAP) file. In some embodiments, the processor of the source wireless device 102A obtains, from the eUICC 108A of the source wireless device 102A, the one or more network addresses, e.g., URL values, for the one or more applet asset servers 402. In some embodiments, the one or more network addresses include one or more application identifier (AID) values, wherein each AID value is paired with a network address for the corresponding applet asset server. In some embodiments, the processor 104A of the source wireless device 102A obtains, from an applet asset discovery server 442, the one or more network addresses, e.g., URL values, for the one or more applet asset servers 402. In some embodiments, the processor 104A of the source wireless device 102A: i) sends, to the applet asset discovery server 442, a first message requesting the one or more network addresses, e.g., URL values, for the one or more applet asset servers 402, and ii) receives, from the applet asset discovery server 442, a second message including one or more application identifier (AID) values, each AID value paired with a network address, e.g., URL value, for the corresponding applet asset server 402. In some embodiments, the first message includes the one or more AID values. In some embodiments, the processor 104A of the source wireless device 102A obtains from the eUICC 108A of the source wireless device 102A one or more application identifier (AID) values and a network address, e.g., a URL value, for the applet asset discovery server 442. In some embodiments, the processor 104A of the source wireless device 102A, for each applet asset server 402 of the one or more applet asset servers 402: i) obtains, from the eUICC 108A of the source wireless device 102A, an AID value for an applet 212 associated with the eSIM 208 and with the applet asset server 402, ii) sends, to the applet asset server 402, a message requesting a subscription service file corresponding to the AID value, and ii) receives, from the applet asset server 402, the subscription service file, where the subscription service file is included in the one or more subscription service files provided to the eUICC 108A of the source wireless device 102A. In some embodiments, the subscription service file includes a newer version of the applet 212 associated with the eSIM 208 installed on the eUICC 108A of the source wireless device 102A. In some embodiments, the eUICC 108A of the source wireless device 102A and/or the processor of the source wireless device 102A saves personalized applet data associated with each applet 212 identified by a corresponding AID value for the eSIM 208. In some embodiments, the eUICC 108A of the source wireless device 102A and/or the processor of the source wireless device 102A transfers the personalized applet data to the eUICC 108B of the target wireless device 102B for personalizing one or more applets of the eSIM 208 transferred to the target wireless device 102B.

FIG. 5B illustrates a flowchart 520 of another exemplary method performed by a source wireless device 102A to transfer an eSIM 208 with applets 212 to a target wireless device 102B. At 522, a processor 104A of the source wireless device 102A retrieves, from local storage at the source wireless device 102A or from remote storage at a network-accessible server, one or more encrypted subscription service corresponding to one or more applets 212 of the eSIM 208 to be transferred from the eUICC 108A of the source wireless device 102A to an eUICC 108B of the target wireless device 102B. At 524, the processor 104A of the source wireless device 102A generates an eSIM export package that includes the eSIM 208 and at least one decrypted version of the one or more encrypted subscription service files. At 526, the processor 104A of the source wireless device 102A sends the eSIM export package to the target wireless device 102B.

In some embodiments, the processor of the source wireless device 102A is external to the eUICC 108A of the source wireless device 102A. In some embodiments, the processor of the source wireless device 102A is integrated with the eUICC 108A of the source wireless device 102A. In some embodiments, the function of the eUICC 108A of the source wireless device is integrated into the processor of the source wireless device 102A. In some embodiments, the processor 104A of the source wireless device 102A generates the eSIM export package in conjunction with, e.g., with the assistance of, the eUICC 108A of the source wireless device 102A.

In some embodiments, generation of the eSIM export package includes the processor of the source wireless device 102A: i) sending, to the eUICC 108A of the source wireless device 102A, the one or more encrypted subscription service files, and ii) receiving, from the eUICC 108A of the source wireless device 102A, the eSIM export package. In some embodiments, at least one of the encrypted subscription service files include an encrypted Customized Applications for Mobile network Enhanced Logic (CAMEL) Application Part (CAP) file. In some embodiments, the processor 104A of the source wireless device 102A: i) receives, from the eUICC 108A of the source wireless device 102A in association with a procedure installing the eSIM 208 on the eUICC 108A of the source wireless device 102A, the one or more encrypted subscription service files, and ii) stores the one or more encrypted subscription service files on the local storage of the source wireless device 102A or on the remote storage of the network-accessible server. In some embodiments, the processor 104A of the source wireless device 102A: i) sends, to the eUICC 108A of the source wireless device 102A, a first message requesting application identifier (AID) data for the one or more applets 212 of the eSIM 208, and ii) receives, from the eUICC 108A of the source wireless device 102A, an array of AID values corresponding to the one or more applets 212 associated with the eSIM 208. In some embodiments, the processor 104A of the source wireless device 102A retrieves the one or more encrypted subscription service files based at least in part on the array of AID values. In some embodiments, the eUICC 108A of the source wireless device 102A saves personalized applet data associated with each applet 212 identified by a corresponding AID value for the eSIM 208, and transfers the personalized applet data to the eUICC 108B of the target wireless device 102B for personalizing one or more applets 212 of the eSIM 208 transferred to the target wireless device 102B.

FIG. 5C illustrates a flowchart 540 of an exemplary method performed by an applet asset server 402 to assist in transfer of an eSIM 208 with applets 212 from a source wireless device 102A to a target wireless device 102B. At 542, the applet asset server 402 receives, from a processor 104A of the source wireless device 102A, a first message requesting one or more subscription service files corresponding to the one or more applets 212 of the eSIM 208, the first message including one or more AID values corresponding to the applets 212 of the eSIM 208. At 544, the applet asset server 402 sends, the processor 104A of the source wireless device 102A, a second message that includes the one or more subscription service files.

In some embodiments, the one or more subscription service files comprise a Customized Applications for Mobile network Enhanced Logic (CAMEL) Application Part (CAP) file. In some embodiments, the one or more subscription service files includes a subscription service file that corresponds to a version an applet 212 of the eSIM 208 installed with the eSIM 208 on an eUICC 108A of the source wireless device 102A. In some embodiments, the one or more subscription service files includes a subscription service file that corresponds to a newer version of an applet 212 of the eSIM 208 installed on the eUICC 108A of the source wireless device 102A.

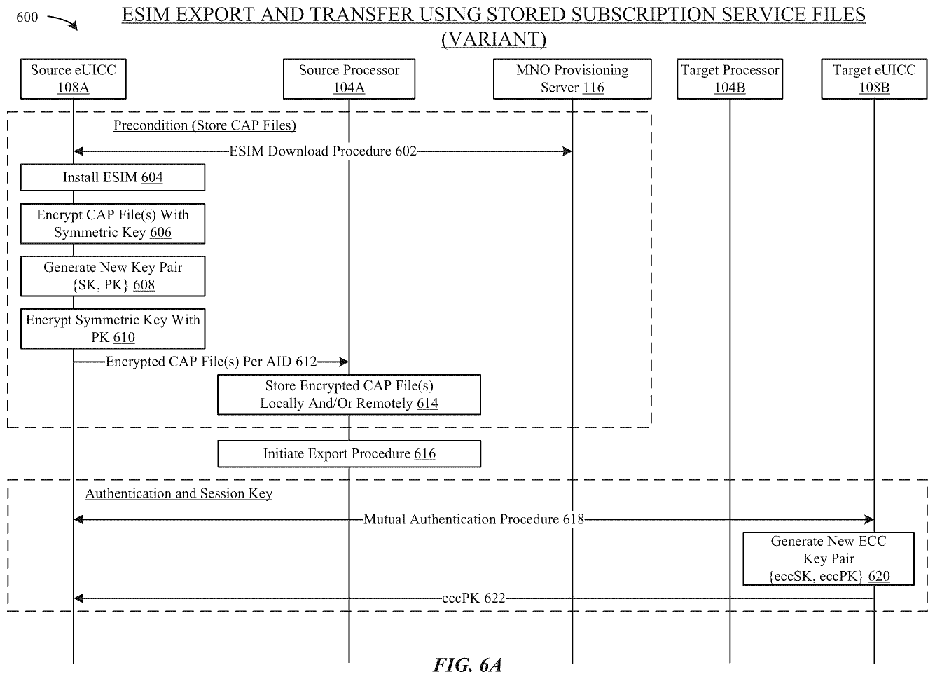

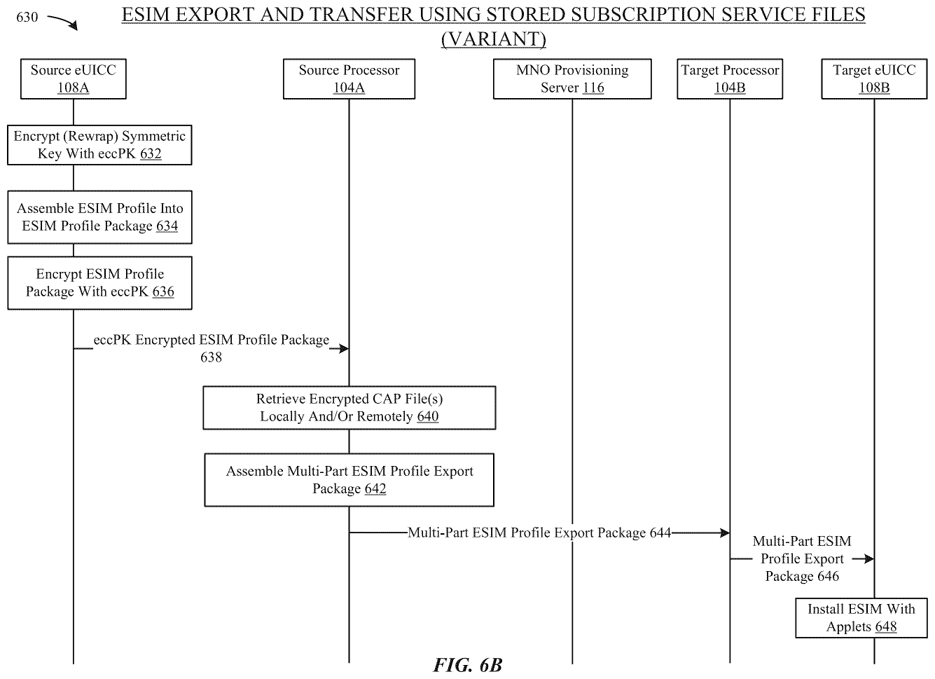

FIGS. 6A and 6B illustrate diagrams 600, 630 of another exemplary sequence of actions performed to export and transfer an eSIM 208, with subscription service files, e.g., CAP files, associated with applets 212 of the eSIM 208, from a source wireless device 102A to a target wireless device 102B. In the variant procedure shown in FIGS. 6A and 6B, actions performed by the eUICC 108A of the source wireless device 102A are reduced compared to the procedure of FIG. 4C, as the processor 104A of the source wireless device 102A, e.g., using a local profile assistant (LPA) executing on the processor 104A, assembles a multi-part eSIM profile export package without requiring decryption of encrypted subscription service files, e.g., encrypted CAP files, and re-assembly by the eUICC 108A of the source wireless device 102A. The multi-part eSIM profile export package can include an eSIM profile core, assembled by the eUICC 108A, and one or more encrypted subscription service files, e.g., one or more encrypted CAP files, retrieved by the processor 104A from local storage or from remote storage for the export procedure, where the one or more encrypted subscription service files were previously encrypted and stored as part of an eSIM installation procedure.

At 602, the eUICC 108A of the source wireless device 102A performs a procedure to download an eSIM 208 from an MNO provisioning server 116. The eSIM 208 can be received as a bound profile package (BPP) that can include one or more subscription service files, e.g., one or more CAP files, for installation of applets 212 associated with the eSIM 208 on the eUICC 108A of the source wireless device 102A. At 604, the eUICC 108A installs the eSIM 208 and one or more applets 212, generated by execution of one or more subscription service files, e.g., one or more CAP files, included with the eSIM 208 in the BPP obtained from the MNO provisioning server 116. Unlike present, customary procedures, the eUICC 108A of the source wireless device 102A, at 606, encrypts the one or more subscription service files, e.g., the one or more CAP files, e.g., with a symmetric key. The eUICC 108A of the source wireless device 102A can include random data along with the one or more subscription service files, e.g., the one or more CAP files, as part of the encryption procedure at 606 to ensure that the encrypted one or more subscription service files, e.g., the one or more CAP files, are unique, i.e., not identical, across different eUICCs 108 of different wireless devices 102. At 608, the eUICC 108A of the source wireless device 102A generates a new asymmetric encryption key pair, {SK, PK}, including a secret (private) key (SK) and a corresponding public key (PK). At 610, the eUICC 108A of the source wireless device 102A encrypts the symmetric key (used to encrypt the one or more subscription service files, e.g., one or more CAP files) with the generated public key PK. The eUICC 108A of the source wireless device 102A, at 612, provides the one or more encrypted subscription service files, e.g., one or more encrypted CAP files, to the processor 104A of the source wireless device 102A. The one or more encrypted subscription service files, e.g., one or more encrypted CAP files, can be referenced according to AID values for applets 212 that can be generated by the respective one or more subscription service files, e.g., one or more CAP files. At 614, the processor 104A of the source wireless device 102A stores the one or more encrypted subscription service files, e.g., one or more encrypted CAP files, locally at the source wireless device 102A and/or remotely at network-accessible storage, e.g., securely in a cloud network service 302 or other secure remote storage. The one or more encrypted subscription service files, e.g., one or more encrypted CAP files, can later be used when exporting the eSIM 208 to the target wireless device 102B.

At 616, the processor 104A of the source wireless device 102A can initiate a procedure to transfer an eSIM 208 from the eUICC 108A of the source wireless device 102A to an eUICC 108B of the target wireless device 102B. At 618, the eUICC 108A of the source wireless device 102A performs a mutual authentication procedure with the eUICC 108B of the target wireless device 102B. At 620, the eUICC 108B of the target wireless device 102B generates a new elliptic curve cryptography (ECC) asymmetric encryption key pair {eccSK, eccPK}, which includes an ECC secret (private) key (eccSK) and an ECC public key (eccPK). The ECC asymmetric encryption key pair can be used for secure communication of the eSIM profile package from the source wireless device 102A to the target wireless device 102B. At 622, the eUICC 108B of the target wireless device 102B provides the ECC public key, eccPK, to the eUICC 108A of the source wireless device 102A.

At 632, the eUICC 108A of the source wireless device 102A rewraps (encrypts) the symmetric key using the ECC public key, eccPK, received from the eUICC 108B of the target wireless device 102B. At 634, the eUICC 108A of the source wireless device 102A assembles the eSIM 208 being transferred into an exportable eSIM profile package, which can include: i) a file system of the eSIM, ii) encryption data, e.g., Ki and other encryption key material, iii) personalized (user-specific) applet data (optional), and iv) the encrypted (rewrapped) symmetric key. At 636, the eUICC 108A of the source wireless device 102A encrypts the assembled eSIM profile package using the ECC public key, eccPK, received from the eUICC 108B of the target wireless device 102B. At 638, the eUICC 108A of the source wireless device provides the eccPK encrypted eSIM profile package to the processor 104A of the source wireless device 102A.

At 640, the processor 104A of the source wireless device 102A retrieves, from local storage and/or from network-accessible remote storage, one or more encrypted subscription services files, e.g., one or more encrypted CAP files, associated with the eSIM 208 being transferred. At 642, the processor 104A of the source wireless device 102A assembles a multi-part eSIM profile export package, which includes i) the eccPK encrypted eSIM profile package received from the eUICC 108A of the source wireless device 102A and ii) at least one of the retrieved one or more encrypted subscription service files, e.g., at least one encrypted CAP file. At 644, the processor 104A of the source wireless device 102A, sends the multi-part eSIM profile export package to the processor 104B of the target wireless device 102B to provide to the eUICC 108B of the target wireless device 102B at 646. At 648, the eUICC 108B of the target wireless device 102B can install the eSIM 208 and associated applets 212, e.g., using the provided one or more subscription services files, e.g., one or more CAP files, (after decryption) included in the eSIM export package. In some embodiments, the applets 212 are personalized by the eUICC 108B of the target wireless device 102B based on personalized applet data for the applets 212 obtained from the eUICC 108A of the source wireless device 102A.

### Representative Device

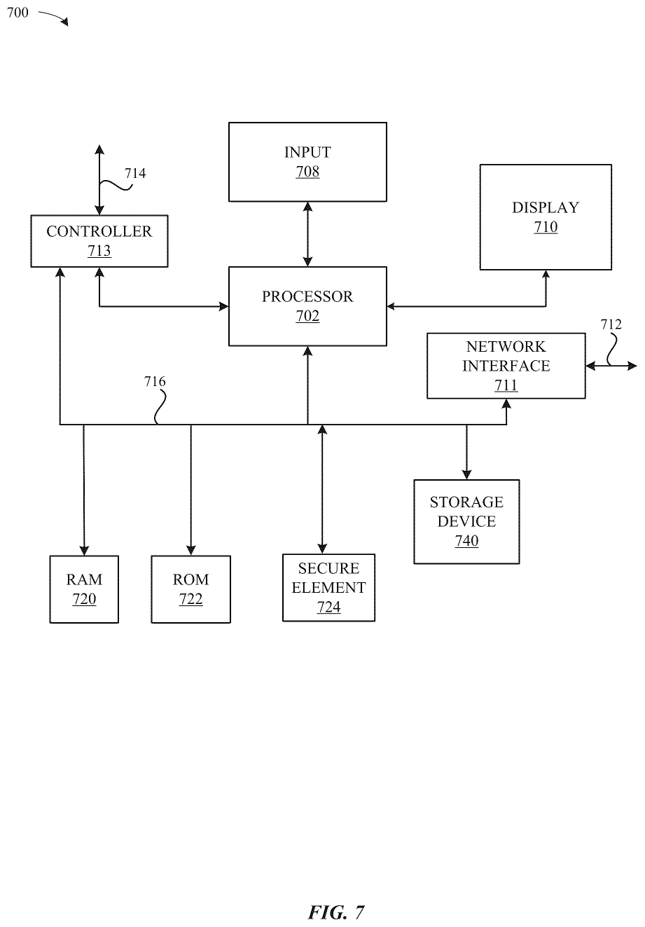

FIG. 7 illustrates a detailed view of a representative computing device 700 that can be used to implement various methods described herein, according to some embodiments. In particular, the detailed view illustrates various components that can be included in a wireless device 102, such as a source wireless device 102A, and/or a target wireless device 102B. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that communicatively couples to a data link 712. In the case of a wireless connection, the network/bus interface 711 can include a wireless transceiver.

The computing device 700 also includes a storage device 740, which can comprise a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700. The computing device 700 can further include a secure element (SE) 724, such as an eUICC 108, a UICC 118, or another secure storage for cellular wireless system access by a wireless device 102, a source wireless device 102A, and/or a target wireless device 102B.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for electronic subscriber identity module (eSIM) transfer from a source wireless device to a target wireless device, the method comprising:
by a processor of the source wireless device:
obtaining one or more network addresses for one or more applet asset servers corresponding to one or more applets associated with the eSIM to be transferred from an embedded universal integrated circuit (eUICC) of the source wireless device to an eUICC of the target wireless device;
obtaining, from the one or more applet asset servers, one or more subscription service files corresponding to the one or more applets of the eSIM;
generating an eSIM export package that includes the eSIM and at least one of the one or more subscription service files; and
sending the eSIM export package to the target wireless device.

2. The method of claim 1, wherein at least one of the one or more subscription service files comprise a Customized Applications for Mobile network Enhanced Logic (CAMEL) Application Part (CAP) file.

3. The method of claim 1, further comprising:
obtaining, from the eUICC of the source wireless device, the one or more network addresses for the one or more applet asset servers.

4. The method of claim 3, wherein:
the one or more network addresses include one or more application identifier (AID) values; and
each AID value is paired with a network address for a corresponding applet asset server of the one or more applet asset servers.

5. The method of claim 1, further comprising:
obtaining, from an applet asset discovery server, the one or more network addresses for the one or more applet asset servers.

6. The method of claim 5, further comprising:
sending, to the applet asset discovery server, a first message requesting the one or more network addresses for the one or more applet asset servers; and
receiving, from the applet asset discovery server, a second message including one or more application identifier (AID) values, each AID value paired with a network address for a corresponding applet asset server of the one or more applet asset servers.

7. The method of claim 6, wherein the first message includes the one or more AID values.

8. The method of claim 5, further comprising:
obtaining, from the eUICC of the source wireless device, one or more application identifier (AID) values and a network address for the applet asset discovery server.

9. The method of claim 1, further comprising:
for each applet asset server of the one or more applet asset servers:
obtaining, from the eUICC of the source wireless device, an AID value for an applet associated with the eSIM and with the applet asset server;
sending, to the applet asset server, a message requesting a subscription service file corresponding to the AID value; and
receiving, from the applet asset server, the subscription service file,
wherein the subscription service file is included in the one or more subscription service files included in the eSIM export package.

10. The method of claim 9, wherein the subscription service file comprises a newer version of the applet associated with the eSIM installed on the eUICC of the source wireless device.

11. The method of claim 1, further comprising:
saving, on the eUICC of the source wireless device, personalized applet data associated with each applet identified by a corresponding AID value for the eSIM.

12. The method of claim 11, further comprising:
transferring, to the eUICC of the target wireless device, the personalized applet data for personalizing one or more applets of the eSIM transferred to the target wireless device.

13. A processor of a source wireless device, the processor configured to:
obtain one or more network addresses for one or more applet asset servers corresponding to one or more applets associated with an electronic subscriber identity module (eSIM) to be transferred from an embedded universal integrated circuit (eUICC) of the source wireless device to an eUICC of a target wireless device;
obtain, from the one or more applet asset servers, one or more subscription service files corresponding to the one or more applets of the eSIM;
generate an eSIM export package that includes the eSIM and at least one of the one or more subscription service files; and
send the eSIM export package to the target wireless device.

14. The processor of claim 13, wherein at least one of the one or more subscription service files comprise a Customized Applications for Mobile network Enhanced Logic (CAMEL) Application Part (CAP) file.

15. The processor of claim 13, wherein:
the processor is further configured to obtain, from the eUICC of the source wireless device, the one or more network addresses for the one or more applet asset servers;
the one or more network addresses include one or more application identifier (AID) values; and
each AID value is paired with a network address for a corresponding applet asset server of the one or more applet asset servers.

16. The processor of claim 13, further configured to:
obtain, from an applet asset discovery server, the one or more network addresses for the one or more applet asset servers;
send, to the applet asset discovery server, a first message requesting the one or more network addresses for the one or more applet asset servers, the first message including one or more application identifier (AID) values; and
receive, from the applet asset discovery server, a second message including the one or more AID values, each AID value paired with a network address for a corresponding applet asset server of the one or more applet asset servers.

17. The processor of claim 13, further configured to:
obtain, from the eUICC of the source wireless device, one or more application identifier (AID) values and a network address for an applet asset discovery server; and
obtain, from the applet asset discovery server, the one or more network addresses for the one or more applet asset servers.

18. The processor of claim 13, further configured to:
for each applet asset server of the one or more applet asset servers:
obtain, from the eUICC of the source wireless device, an AID value for an applet associated with the eSIM and with the applet asset server;
send, to the applet asset server, a message requesting a subscription service file corresponding to the AID value; and
receive, from the applet asset server, the subscription service file,
wherein:
the subscription service file is included in the one or more subscription service files included in the eSIM export package; and
the subscription service file comprises a newer version of the applet associated with the eSIM installed on the eUICC of the source wireless device.

19. The processor of claim 13, further configured to:
save, on the eUICC of the source wireless device, personalized applet data associated with each applet identified by a corresponding AID value for the eSIM; and
transfer, to the eUICC of the target wireless device, the personalized applet data for personalizing one or more applets of the eSIM transferred to the target wireless device.

20. A non-transitory computer readable medium storing instructions for configuring a processor of a source wireless device, the instructions comprising:
instructions for obtaining one or more network addresses for one or more applet asset servers corresponding to one or more applets associated with an electronic subscriber identity module (eSIM) to be transferred from an embedded universal integrated circuit (eUICC) of the source wireless device to an eUICC of a target wireless device;
instructions for obtaining, from the one or more applet asset servers, one or more subscription service files corresponding to the one or more applets of the eSIM;
instructions for generating an eSIM export package that includes the eSIM and at least one of the one or more subscription service files; and
instructions for sending the eSIM export package to the target wireless device.
